(19) United States
(12) Patent Application Publication
(10) Pub. No.: US 2019/0083948 A1
(43) Pub. Date: Mar. 21, 2019

(54) STIRRER HEAD HAVING AN IDENTIFICATION DEVICE

(71) Applicant: Zeta Biopharma GmbH, Lieboch (AT)

(72) Inventor: Georg PÖSCHL, Graz (AT)

(21) Appl. No.: 16/132,979

(22) Filed: Sep. 17, 2018

(30) Foreign Application Priority Data
Sep. 18, 2017 (AT) A 50786/2017

(51) Int. Cl. B01F 13/08; G06K 19/07

(52) U.S. Cl. CPC B01F 13/0845; G06K 19/0723

(57) ABSTRACT

A stirrer head having a bearing boss, a bearing bushing, at least one stirrer vane and a coupling section, wherein the bearing boss has an external surface and an internal surface and the bearing bushing is form-fit into the bearing boss, resting on the internal surface, wherein the stirrer vane is connected to the coupling section and the external surface of the bearing boss, wherein the stirrer head has an identification device and the bearing boss has a through-opening between the external surface and the internal surface, the identification device is positioned in the through-opening and the stirrer vane closes the through-opening at the external surface.

The invention relates to a stirrer head having a bearing boss, a bearing bushing, at least one stirrer vane and a coupling section, wherein the bearing boss has an external surface and an internal surface, and wherein the bearing bushing is form-fit into the bearing boss, resting on the internal surface, wherein the stirrer vane is connected to the coupling section and the external surface of the bearing boss.

The invention further relates to a method for providing a stirrer head with an identification device.

In the fields of biopharmaceutical industry, food industry and in the area of aseptic liquid production processes, stirrer heads are used as part of stirring units in stirrer vessels. The stirrer vessels are generally configured as gas-tight and closable kettle-shaped vessels made from metal or glass, which ensure simple purification and sterilization and, hence, multiple use. Thorough mixing of a stirring medium received in the stirrer vessel is performed within the stirrer vessel by means of the stirrer head of the stirring unit, which may have one or several stirrer vanes, according to the type of application. The stirrer head may further be connected to a stirrer shaft having stirrer shaft vanes arranged thereon in order to homogenously mix stirrer media in vessels having a larger volume. Mounting of the stirrer head of such stirring units is carried out via a rotary bearing, such as, e.g., a slide bearing, which has a bearing boss and a bearing bushing arranged therein. In the areas of use mentioned above, there are demanded high levels of standard in regard to the sterility of the products, which is why production, storage and transport of these have to be carried out under sterile conditions. In the construction of biopharmaceutical facilities, aseptically designed stirring units are state of the art. Herein, there are effective special requirements regarding material and surface quality of the stirrer heads and of further components of the stirring unit. There are, for example, used austenite steels having a low ferrite content, which acquire, by way of electric polishing, a finishing surface refining. In this way, peaks and recesses of the surface of parts are smoothed, whereby the adherability of germs and thus the risk of cross-contamination are being reduced.

The EP 1 748 201 B1 discloses a stirrer head, which has a magnetic coupling between driving unit and stirring unit. This further has a rotary bearing in the form of a slide bearing having a bearing boss and a bearing bushing accommodated therein.

A disadvantage of prior-art stirrer heads is that the stirrer heads, due to the surface treatment, e.g., by means of electric polishing, do not have unique identification features anymore. Labelling the stirrer heads by means of etching, stamp labelling or any other surface alterating methods is often rejected by the operators of the facilities due to hygienic reasons. It is especially disadvantageous that in the course of disassembling and maintenance works of biopharmaceutical facilities or facilities in the food industry, there cannot be made an allocation of individual stirrer heads to further parts of a stirring unit in the disassembled state. This will lead to the risk of mistaking stirrer heads increasing and possibly stirrer heads being mixed up. It is, however, not advantageous from an operational point of view to exchange parts of stirring units for another during inspection works. For example, the state of wear of the bearing bushings may be derived from the operational hours of a stirring unit. Furthermore, mistaking and, hence, inadvertent mixing up of bearing components arriving together will lead to a substantially increased wear and, in the worst case, to contamination of the stirring medium.

It is the task of the present invention to create a stirrer head and a method, which prevent the disadvantages mentioned above.

According to the invention, the present task is solved by the stirrer head having an identification device and the bearing boss having a through-opening between the external surface and the internal surface, the identification device being positioned in the through-opening and the stirrer vane closing the through-opening at the external surface.

The present task is further solved by a method for providing a stirrer head with an identification device using the following method steps:
a) Forming a through-opening from one external surface towards an internal surface of the bearing boss of the stirrer head;
b) Connecting a stirrer vane to the external surface in a position covering the through-opening and closing the through-opening at the external surface;
c) Inserting the identification device in the through-opening;
d) Heating the stirrer head;
e) Fitting a bearing boss at the internal surface in a position covering the through-opening and closing the through-opening at the internal surface.

The configuration of the stirrer head according to the invention provides an identification device, which is positioned in a through-opening, which is configured between an external surface and an internal surface of a bearing boss of the stirrer head. A bearing bushing is fitted into the internal surface of the bearing boss. At the external side of the bearing boss, a stirrer vane is connected to the bearing boss such that the through-opening on the external surface is closed. In this way, there is achieved the advantage that no liquid such as, e.g., stirring medium, may enter the through-opening from the external surface of the bearing boss and negatively affect the function of the identification device. The configuration of the stirrer head according to the invention offers the advantage that by the identification device positioned in the through-opening there is provided the possibility to identify the stirrer head in a unique way also without alteration of the surface thereof. It is especially advantageous that there may also be performed an automated identification in the case of disassembly of the stirrer head by way of the configuration of the identification device as a RFID chip.

Advantageous embodiments of the stirrer head according to the invention and of the method as well as alternative embodiments are explained in greater detail by way of the figures in the following.

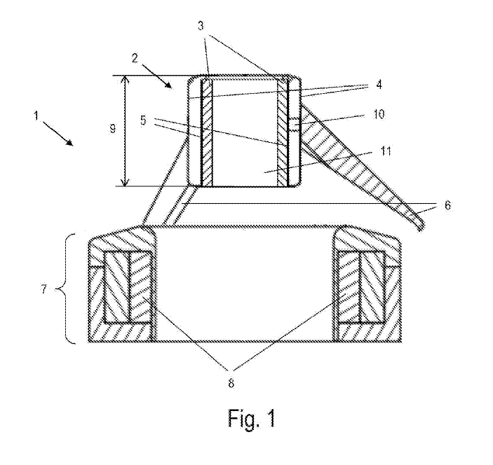

FIG. 1 shows a sectional view through a stirrer head according to the invention in a side view.

FIG. 1 shows a stirrer head 1 according to the invention in a sectional view from the side, having a bearing boss 2 and a bearing bushing 3 accommodated in the bearing boss 2. The bearing boss 2 has an external surface 4 and an internal surface 5, and the bearing bushing 3 is form-fit into the bearing boss 2, wherein the bearing bushing 3 rests on the internal surface 5 of the bearing boss 3. The stirrer head 1 that is depicted in FIG. 1 in a preferred embodiment has three stirrer vanes 6, wherein in the sectional view of FIG. 1 two stirrer vanes 6 thereof are visible. In general, embodiments of the stirrer head 1 according to the invention have at least one stirrer vane 6. The stirrer head 1 furthermore has a coupling section 7, wherein the stirrer vanes 6 are connected to the external surface 4 of the bearing boss 2 and the coupling section 7. The coupling section 7 comprises coupling magnets 8 in a preferred embodiment of the stirrer head 1. In operation of the stirrer head 1, these are magnetically coupled to the coupling magnets of a drive of a stirring unit and, hence, form a drive coupling, which transfers a torque of the drive to the stirrer head 1, setting it into rotation. In the preferred embodiment illustrated in FIG. 1, the stirrer vanes 6 are connected to the external surface 4 thereof essentially along a height 9 of the bearing boss 2. In alternative embodiments, the stirrer vanes 6 may also be connected, e.g., point-wise, at an upper or lower section of the external surface 4, which is perpendicular to the height 9 of the bearing boss 2. The external surface 4, hence, comprises the entire height 9 of the bearing boss 2 as well as an essentially perpendicular section thereto at the upper and the lower end of the bearing boss 2. The bearing boss 2 of the stirrer head 1 further has a through-opening 10 between the external surface 4 and the internal surface 5, in which an identification device, which is not depicted in FIG. 1, of the stirrer head 1 is positioned. One of the stirrer vanes 6 closes the through-opening 10 at the external surface of the bearing boss 2. In this way, there is obtained the advantage that the identification device is accommodated by the bearing boss 2 in liquid-tight way and protected against mechanic influences at the external surface 4. It is especially advantageous that the surface property of the stirrer head 1 is not negatively affected by the accommodation of the identification device and that a homogenously smooth surface of the stirrer head 1 may be maintained.

In a preferred embodiment the identification device is a plastic-sheathed RFID chip. In this way, there is obtained the advantage that the identification device may be read in a contactless way. The plastic provides a protection sleeve for the RFID chip and additionally closes the through-opening 10, which is why the RFID chip does not come into contact with a stirring medium, which is mixed by the stirrer head 1. The plastic is preferably embodied as a FDA-compliant plastic, which gives the advantage that the stirrer head 1 according to the invention meets the requirements of the biopharmaceutical industry.

According to a further preferred embodiment, the bearing bushing 3 closes the through-opening 10 at the internal side 5. In this way, there is obtained the advantage that the through-opening is closed at the external side 4 by the stirrer vane 6 as well as at the internal side 5 by the bearing bushing 3. It is especially advantageous that in this way there is provided additional protection for the identification device and that no liquid as, for example, a stirring medium, may enter the through-opening 10.

The bearing bushing 3 is preferably embodied as a ceramic slide bearing bushing. The bearing boss 2 and the further components of the stirrer head 1 are in general made from metallic materials, which electromagnetically shield the identification device. Because of the configuration of the bearing bushing 3 as a ceramic slide bearing bushing, there is obtained the advantage that the identification device may be read in an electromagnetically contactless way from a position within a cavity 11 that is defined by the bearing boss 2 or the bearing bushing 3, respectively. For this purpose, in a state of the stirrer head 1 disassembled by the stirring unit a reader, for example an antenna, is introduced in this cavity 11.

The stirrer head 1 depicted in FIG. 1 represents a part of a stirring unit, which is inserted into a stirrer vessel for mixing the stirring medium received therein. A stirring unit comprises a drive having a drive coupling section, which forms a releasable drive coupling with the coupling section 7 of the stirrer head 1. The stirring unit further has a counter-bearing, on which the bearing bushing 3 is rotatably mounted. In a preferred embodiment of the stirring unit, the counter-bearing comprises the reader, for example in the form of an antenna. The identification device, hence, may be read in a contactless way by the reader in the counter-bearing at any point of time. In this way there is obtained the advantage that the stirrer head 1 need not be removed from the stirring unit for reading the identification device, as previously described. Herein, it is especially advantageous that reading the identification device is enabled at any point of time, also during the operation of the stirring unit or of the stirrer head 1, respectively.

The counter-bearing especially preferably has a ceramic slide bearing bushing. In this way there is obtained the advantage that the counter-bearing is especially wear-resistant and that the arrangement of the reader and the reading of the identification device are facilitated. In particular if the bearing bushing 3 of the stirrer head 1 is also embodied as a ceramic slide bearing bushing, then we have the advantage that there is enabled an especially wear-resistant operation of the stirring unit.

The method for providing a stirrer head 1 with an identification device according to the invention has the following method steps: At first, there is formed the through-opening 10, starting from the external surface 4 of the bearing boss 2 towards the internal surface 5. The through-opening 10 is preferably drilled. Subsequently, the stirrer vane 6 is connected to the external surface 4 in a position covering the through-opening 10, whereby the through-opening 10 is closed at the external surface 4. By way of this method sequence, there is achieved the advantage that a bag hole in the bearing boss 2 opened towards the internal surface 5 is provided, without being necessary to form this starting from the internal surface 5. The connection between the stirrer vane 6 and the external surface 4 is created, e.g., by welding. Forming a bag hole starting from the internal surface 5 will lead to the procedural problem that within the bearing boss 2 there will be available in general too little space in order to introduce suitable tools such as, for example, drill bits in order to form a bag hole starting from the internal surface 5. Due to the method according to the invention there is obtained the advantage that this problem is avoided. Subsequently, the identification device is inserted in the through-opening 10. In this way there is obtained the advantage that the identification device is arranged protected against environmental influence between the external surface 4 and the internal surface 5 of the bearing boss 2 in the through-opening 10. If the identification device is provided as a plastic-sheathed RFID chip, then there is given the additional advantage that the plastic seals the through-opening 10 from the internal surface 5. In the subsequent method step the stirrer head 1 is heated. Heating of the stirrer head 1 causes a thermal expansion of the bearing boss 2, whereby in the final method step the bearing bushing 3 may be fit at the internal surface of the bearing boss 2 in a position covering the through-opening 10. In this way, the through-opening 10 is closed at the internal surface 5. Thereby there is obtained the advantage that the bearing bushing 3 closes the identification device at the internal surface 5 of the bearing boss 2 in a liquid-tight way and protects it against mechanical influences.

It is to be noted that the identification device may also have a writable data storage in order to store data in the identification device. Such data might, for example, comprise service life or service frequency of the stirrer head, which are stored in the identification device by an RFID reader of the stirring unit. Also technical problems arising while stirring, such as increased friction or abutting bearings, might be stored in the data storage for service technicians.

In a further embodiment of the invention, the identification device could also be a ceramic-sheathed RFID chip. In this way there is obtained the advantage that the identification device that is readable in a contactless way is especially well-protected in regard to mechanics by the hard and resistant ceramic material.

1. A stirrer head comprising:
a bearing boss, a bearing bushing, at least one stirrer vane and a coupling section, wherein the bearing boss has an external surface and an internal surface and the bearing bushing is form-fit into the bearing boss, resting on the internal surface, wherein the stirrer vane is connected to the coupling section and the external surface of the bearing boss, wherein
the stirrer head has an identification device and the bearing boss has a through-opening between the external surface and the internal surface, the identification device is positioned in the through-opening and the stirrer vane closes the through-opening at the external surface.

2. A stirrer head according to claim 1, characterized in that the bearing bushing closes the through-opening at the internal side.

3. A stirrer head according to claim 1, characterized in that the identification device is a plastic-sheathed RFID chip.

4. A stirrer head according to claim 1, characterized in that the bearing bushing is a ceramic slide bearing bushing.

5. A stirring unit for a stirrer vessel, comprising: a stirrer head according to claim 1, wherein the stirring unit comprises a drive having a drive coupling section, wherein the drive coupling section and the coupling section of the stirrer head form a releasable drive coupling, and the stirring unit has a counter-bearing, wherein the bearing bushing is rotatably mounted on the counter-bearing, and the counter-bearing has a reader, which is configured to read the identification device in a contactless way.

6. A stirring unit according to claim 5, wherein the counter-bearing has a ceramic slide bearing bushing.

7. A method for providing a stirrer head with an identification device, comprising
forming a through-opening from an external surface towards an internal surface of a bearing boss of the stirrer head;
connecting a stirrer vane to the external surface in a position covering the through-opening and closing the through-opening at the external surface;
inserting the identification device in the through-opening;
heating the stirrer head;
fitting a bearing bushing at the internal surface in a position covering the through-opening and closing the through-opening at the internal surface.
